(19) United States
(12) Patent Application Publication
(10) Pub. No.: US 2017/0036188 A1
(43) Pub. Date: Feb. 9, 2017

(54) PROCESS FOR MAKING A SUPER ABSORBENT COMPOSITION

(71) Applicant: GREEN ENERGY MCI LLC, St. Ansgar, IA (US)

(72) Inventors: Dan Freeman, St. Ansgar, IA (US); Stephan J. Smith, St. Ansgar, IA (US)

(21) Appl. No.: 15/174,529

(22) Filed: Jun. 6, 2016

Related U.S. Application Data
(60) Provisional application No. 62/201,633, filed on Aug. 6, 2015.

(51) Int. Cl. B01J 20/24; A01G 31/00; B01J 20/30; A01K 1/015; B02C 23/08; B01J 20/10

(52) U.S. Cl. CPC B01J 20/24; B02C 23/08; B01J 20/106; B01J 20/3035; B01J 20/3007; A01K 1/0152; A01G 31/001; A01G 2031/007

(57) ABSTRACT

A method for making a super absorbent composition where feedstock is broken into clumps, the clumps are transported to a compression section, where the clumps are heated using compression and friction. Next, the compressed clumps are cooled and then broken into a super absorbent material.

### CROSS-REFERENCE TO RELATED APPLICATIONS

This application claims priority to Provisional Application U.S. Ser. No. 62/201,633 filed on Aug. 6, 2015, which is herein incorporated by reference in its entirety.

### BACKGROUND OF THE INVENTION

An objective of the present invention is to provide a process for making super absorbent composition that is less expensive and takes less time.

Another objective of the present invention is to provide a process for making a composition that will absorb almost six times its weight in moisture.

These and other objectives will be apparent to those skilled in the art based upon the following written description, drawings and claims.

### SUMMARY OF THE INVENTION

A process for making a super absorbent composition, including the step of breaking feedstock having a desired moisture content, into small clumps. Once broken, the clumps are transported to a compression section of a briquetting system. Within the compression section, the clumps are heat treated through compression and friction using heated dies, hammers and pistons. Once the compressed clumps are pushed through the dies, they are pushed through a tightener.

From the tightener, the compressed clumps are moved to a cooling line where the compressed clumps are cooled to a surface temperature of between 65° F. to 165° F. Once cooled, preferably the cooled compressed clumps are dropped into a vertical chain mill breaker.

For use as bedding, the broken compressed clumps are dropped onto an oscillating screen where fines are removed. For horticulture use, the broken compressed clumps are mixed with perlite.

### BRIEF DESCRIPTION OF THE FIGURES

FIG. 1 is a flow diagram for a method of making a super absorbent composition;

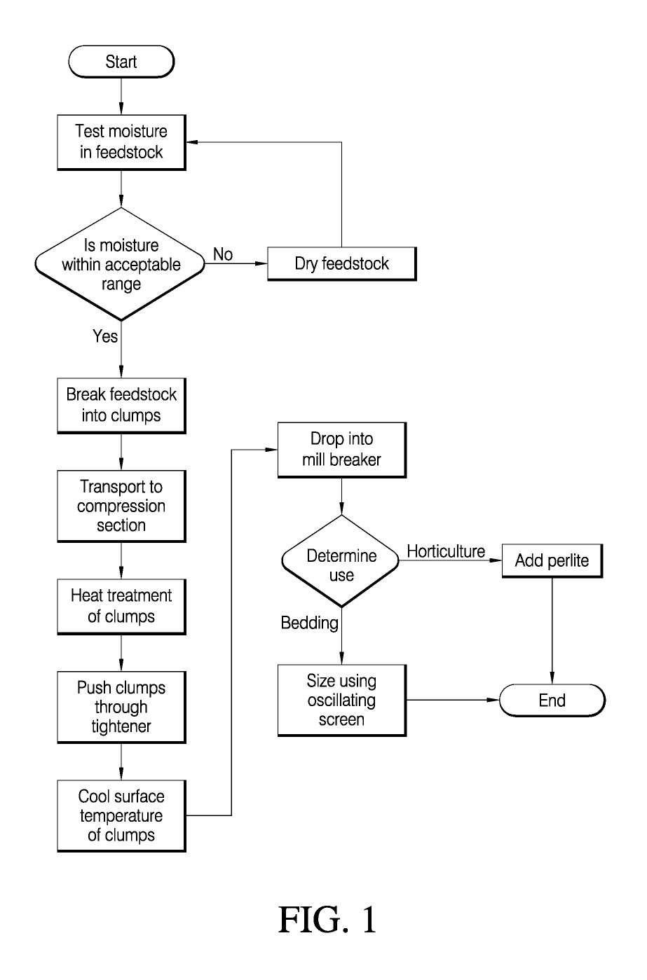

FIG. 2 is a schematic diagram of an environment for making a super absorbent composition.

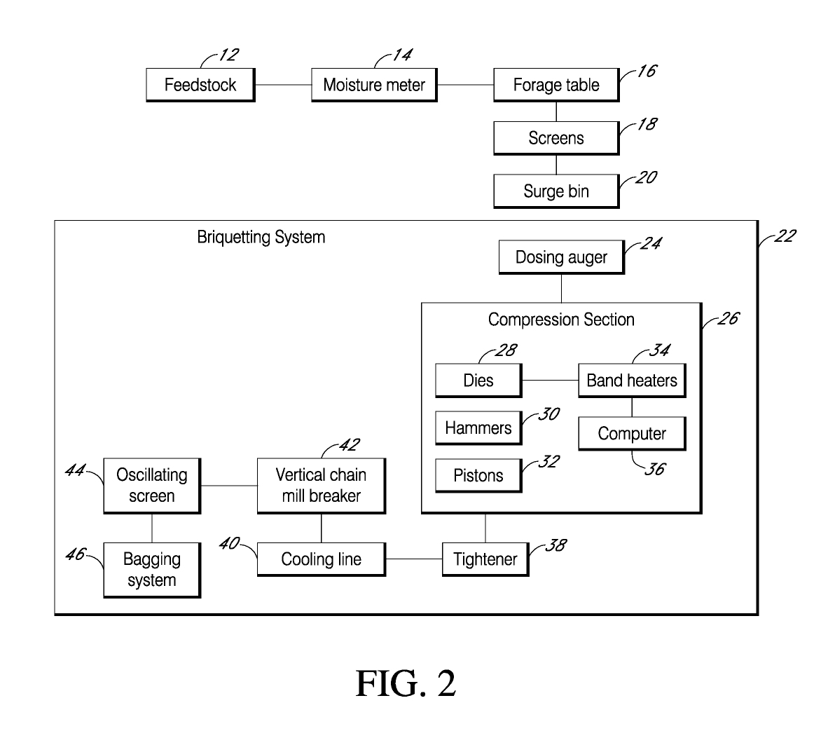

### DETAILED DESCRIPTION OF THE PREFERRED EMBODIMENTS

Referring to the Figures, a process for making a super absorbant composition such as straw begins by obtaining a feedstock 12. The feedstock 12 is of various species of grasses or grains such as wheat straw, corn stover, and oat straw. Also, switchgrass and miscanthus are used.

Once obtained, each bale of feedstock 12 is tested for moisture using a moisture meter 14. Preferably, the bale has a moisture of between 8-20%. If not within the moisture range, bales are run through a bale dryer to lower moisture to the desired range. Bales of feedstock are then processed using a specialized forage table 16 where the bales are broken into small clumps. The clumps are broken or ground preferably to a size of ⅛ inch to 1 inch for horticulture products and 1 inch for bedding products. Screens 18 are used to size the clumps.

The ground or clumps are then fed into a surge bin 20 of a briquetting system 22. Ground/clumped material is transported from the surge bin 20 using a dosing auger 24 where the material is dropped into a compression section 26 of system 22, where the material is processed using specialized dies 28 and hammers 30. A reciprocating piston 32 pushes the material into a tapered die 28 which pushes the materal remaining in the die 28 from the previous stroke. In mechanical systems, the piston 32 is mounted eccentrically on a crank-shaft with a flywheel. The shaft, piston rod and guide for the rod are held in an oil bath. The moving parts are mounted to a frame and the flywheel is driven by an electric motor geared down through a V-belt coupling.

Heating of the material during the briquette process occurs through a combination of friction and compression. The dies 28 are heated to approximately 100° C. by means of electrical band heaters 34 controlled by a computer 36. Once the briquetting process begins the friction and pressure achieve temperatures between 240°-250° F. which is hot enough to extrude lignin and cause the material to stick together. Heating the material also boils off any remaining moisture and causes steam to explode the cell structure of the material.

The piston top preferably is shaped with a protruding half-spherical section in order to obtain better adherence of the newly compressed material to that formed in the previous stroke. The piston and die preferably have a diameter of between 50-90 mm and the die tapers toward the middle and then increases again before the end. The pressure for compression is preferably between 17,000 to 29,000 psi.

Once the material is pushed through the dies 28, the material is pushed through a tightener 38 which keeps back pressure on the compressed materal. From the tightener 38, compressed material is moved to a cooling line 40 where the compressed material is allowed to expand and cool. Preferably, while within the cooling line, the surface temperature of the compressed material is dropped to approximately 95°-165° F.

From the cooling line 40 the compressed material is transported to and dropped into a vertical chain mill breaker 42. Preferably, The breaker 42 has two rows of chain that spin on a belt driven shaft which breaks the compressed materal without forcing the materal through a screen which would create additional fines.

Once broken, for use as bedding, the material is dropped onto an oscillating screen 44 having a size ranging from 0.020 to 0.060 inches. The screen removes fines that are detrimental to small animals respiratory systems. The removed fines are used for pelletized bedding products or as absorbents for liquids.

For horticulture use, the broken material is not screened and instead is mixed with perlite. Preferably, the inclusion of pertilite is 0.25% to 5% of weight. Alternatively, pertilite may be added at a high percentage, such as between 50% and 67%.

Next, the material, whether screened or not, is dropped into totes or directly into a bagging system 46. The bagging system 46 measures the needed material (i.e. 10-50 lbs per bag) and a hydraulic cylinder is used to exert pressure and fill a gusseted bag of finished material and then the bag is heat sealed.

Bags are then labeled with an adhesive label and then palletized for shipment. Alternatively, the bags are pre-printed.

This process produces a super absorbent composition, and in particular super absorbent straw. Super absorbent is defined as a composition that will absorb almost six times its weight in moisture. The super absorbent composition has many uses including bedding for animals ranging from small caged household pets to large horses and farm animals; horticulture products such as germination media, organic amendment for soils, and hydroponic growing mediums; and absorbent booms such as tubular absorbents that can be used to absorb water, oil, and anti-freeze coolants and the like. The super absorbent composition is also used for anti-erosion booms such as tubular booms used to help keep soil from eroding, greendry, sweeps such as a floor sweep absorbent; and for the inclusion in methane digesters to increase methane production by 30-40%.

What is claimed:

1. A method for making a super absorbent composition, comprising the steps of:
breaking feedstock into clumps;
transporting the clumps to a compression section of a briquetting system;
heating the clumps in the compression section using friction and compression;
cooling the compressed clumps; and
breaking the compressed clumps to produce the super absorbent composition.

2. The method of claim 1 further comprising the step of testing the feedstock for moisture.

3. The method of claim 2 further comprising the step of drying the feedstock when the feedstock exceeds a predetermined moisture percentage.

4. The method of claim 1 wherein screens are used to size the clumps during the step of breaking the feedstock into clumps.

5. The method of claim 1 wherein the clumps are heated to a temperature sufficient to extrude lignin, boil of moisture in the clumps, and cause steam to explode cell structure of the clumps.

6. The method of claim 1 wherein the heating step includes reciprocating pistons that push the clumps through heated dies.

7. The method of claim 6 further comprising the step of pushing the heated compressed clumps through a tightener.

8. The method of claim 1 wherein the step of cooling the compressed clumps includes cooling the compressed clumps until a surface temperature of the compressed clumps between 95° F. to 165° F. is reached.

9. The method of claim 1 wherein the step of breaking the compressed clumps includes the use of a vertical chain mill breaker.

10. The method of claim 1 further comprising the step of mixing the broken compressed clumps with perlite.

11. The method of claim 1 further comprising the step of screening the broken compressed clumps.
